(19) United States
(12) Patent Application Publication
(10) Pub. No.: US 2023/0230368 A1
(43) Pub. Date: Jul. 20, 2023

(54) INFORMATION PROCESSING APPARATUS, INFORMATION PROCESSING METHOD, AND PROGRAM

(71) Applicant: Sony Semiconductor Solutions Corporation, Kanagawa (JP)

(72) Inventor: Takafumi Shokonji, Kanagawa (JP)

(21) Appl. No.: 17/996,402

(22) PCT Filed: May 11, 2021
(86) PCT No.: PCT/JP2021/017800

§ 371 Date: Oct. 17, 2022

(30) Foreign Application Priority Data
May 25, 2020 (JP) 2020-090538

(51) Int. Cl. G06V 10/80; G06V 20/56

(52) U.S. Cl. CPC G06V 10/803; G06V 20/56

(57) ABSTRACT

The present technology relates to an information processing apparatus, an information processing method, and a program capable of obtaining a distance to an object more accurately.

An extraction unit extracts, on the basis of an object recognised in an imaged image obtained by a camera, sensor data corresponding to an object region including an object in the imaged image among sensor data obtained by a rangefinding sensor. The present technology can be applied to an evaluation apparatus for distance information, for example.

### TECHNICAL FIELD

The present technology relates to an information processing apparatus, an information processing method, and a program, and more particularly, relates to an information processing apparatus, an information processing method, and a program capable of more accurately obtaining a distance to an object.

### BACKGROUND ART

Patent Document 1 discloses a technology for generating rangefinding information for an object on the basis of a rangefinding point in a rangefinding point arrangement region set in an object region in distance measurement using a stereo image.

### CITATION LIST

### Patent Document

Patent Document 1: International Publication No. 2020/017172

### SUMMARY OF THE INVENTION

### Problems to be Solved by the Invention

However, there is a possibility that the accurate distance to an object cannot be obtained depending on the state of the object recognized in the image only by using the rangefinding point set in the object region.

The present technology has been made in view of such a situation, and makes it possible to more accurately obtain the distance to an object.

### Solutions to Problems

An information processing apparatus of the present technology is an information processing apparatus including an extraction unit that extracts, on the basis of an object recognized in an imaged image obtained by a camera, sensor data corresponding to an object region including the object in the imaged image among the sensor data obtained by a rangefinding sensor.

An information processing method of the present technology is an information processing method in which an information processing apparatus extracts, on the basis of an object recognized in an imaged image obtained by a camera, sensor data corresponding to an object region including the object in the imaged image among the sensor data obtained by a rangefinding sensor.

A program of the present technology is a program for causing a computer to execute processing of extracting, on the basis of an object recognized in an imaged image obtained by a camera, sensor data corresponding to an object region including the object in the imaged image among the sensor data obtained by a rangefinding sensor.

In the present technology, on the basis of an object recognized in an imaged image obtained by a camera, sensor data corresponding to an object region including the object in the imaged image is extracted among the sensor data obtained by a rangefinding sensor.

### BRIEF DESCRIPTION OF DRAWINGS

FIG. 1 is a block diagram illustrating a configuration example of a vehicle control system.

FIG. 2 is a view illustrating an example of a sensing region.

FIG. 3 is a view illustrating evaluation of distance information of a recognition system.

FIG. 4 is a block diagram illustrating a configuration of an evaluation apparatus.

FIG. 5 is a view for explaining an example of point cloud data extraction.

FIG. 6 is a view for explaining an example of point cloud data extraction.

FIG. 7 is a view for explaining an example of point cloud data extraction.

FIG. 8 is a view for explaining an example of point cloud data extraction.

FIG. 9 is a view for explaining an example of point cloud data extraction.

FIG. 10 is a view for explaining an example of point cloud data extraction.

FIG. 11 is a flowchart explaining evaluation processing of distance information.

FIG. 12 is a flowchart explaining extraction condition setting processing for point cloud data.

FIG. 13 is a flowchart explaining extraction condition setting processing for point cloud data.

FIG. 14 is a view explaining a modification of point cloud data extraction.

FIG. 15 is a view explaining a modification of point cloud data extraction.

FIG. 16 is a view explaining a modification of point cloud data extraction.

FIG. 17 is a view explaining a modification of point cloud data extraction.

FIG. 18 is a view explaining a modification of point cloud data extraction.

FIG. 19 is a view explaining a modification of point cloud data extraction.

FIG. 20 is a view explaining a modification of point cloud data extraction.

FIG. 21 is a view explaining a modification of point cloud data extraction.

FIG. 22 is a block diagram illustrating a configuration of an information processing apparatus.

FIG. 23 is a flowchart explaining rangefinding processing of an object.

FIG. 24 is a block diagram illustrating a configuration example of a computer.

### MODE FOR CARRYING OUT THE INVENTION

Modes for carrying out the present technology (hereinafter, embodiments) will be described below. Note that the description will be given in the following order.

1. Configuration example of vehicle control system

2. Evaluation of distance information of recognition system

3. Configuration and operation of evaluation apparatus

4. Modification of point cloud data extraction

5. Configuration and operation of information processing apparatus

6. Configuration example of computer

### 1. Configuration Example of Vehicle Control System

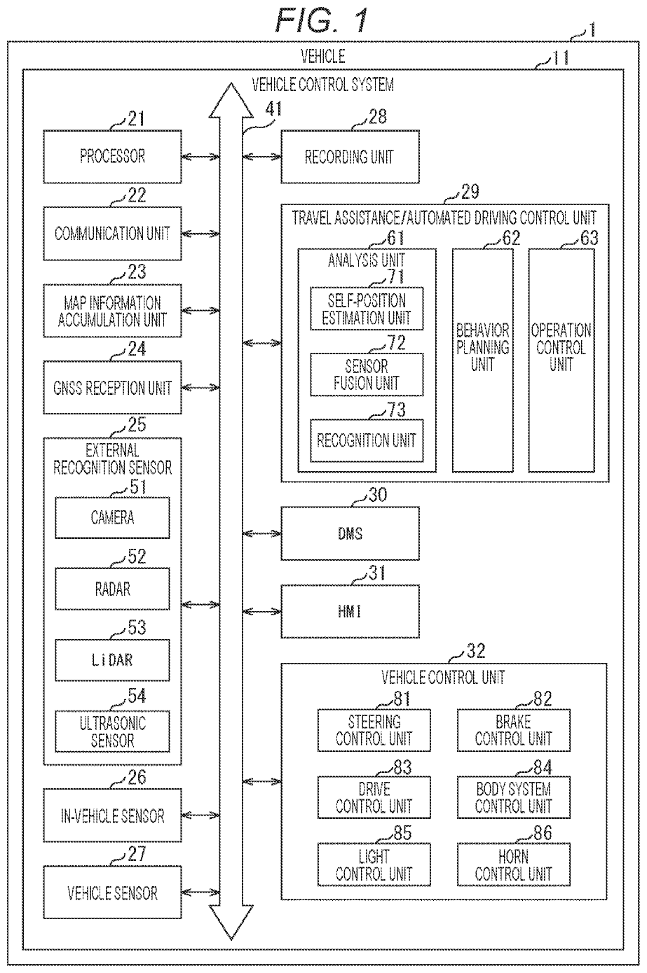

FIG. 1 is a block diagram illustrating a configuration example of a vehicle control system 11, which is an example of a mobile apparatus control system to which the present technology is applied.

The vehicle control system 11 is provided in a vehicle 1 and performs processing related to travel assistance and automated driving of the vehicle 1.

The vehicle control system 11 includes a processor 21, a communication unit 22, a map information accumulation unit 23, a global navigation satellite system (GLASS) reception unit 24, an external recognition sensor 25, an in-vehicle sensor 26, a vehicle sensor 27, a recording unit 28, a travel assistance/automated driving control unit 29, a driver monitoring system (DMS) 30, a human machine interface (HMI) 31, and a vehicle control unit 32.

The processor 21, the communication unit 22, the map information accumulation unit 23, the GNSS reception unit 24, the external recognition sensor 25, the in-vehicle sensor 26, the vehicle sensor 27, the recording unit 28, the travel assistance/automated driving control. unit 29, the driver monitoring system (DMS) 30, the human machine interface (HMI) 31, and the vehicle control unit 32 are connected to one another via a communication network 41. The communication network 41 includes, for example, a vehicle-mounted communication network conforming to a discretionary standard such as a controller area network (CAN), a local interconnect network (LIN), a local area network (LAN), FlexRay (registered trademark), or Ethernet (registered trademark), a bus, and the like. Note that there is a case where each unit of the vehicle control system 11 is directly connected by, for example, near field communication (NFC), Bluetooth (registered trademark), and the like without via the communication network 41.

Note that hereinafter, in a case where each unit of the vehicle control system 11 performs communication via the communication network 41, description of the communication network 41 will be omitted. For example, in a case where the processor 21 and the communication unit 22 perform communication via the communication network 41, it is simply described that the processor 21 and the communication unit 22 perform communication.

The processor 21 includes various processors such as a central processing unit (CPU), a micro processing unit (MPU), and an electronic control unit (ECU). The processor 21 controls the entire vehicle control system 11.

The communication unit 22 communicates with various equipment inside and outside the vehicle, other vehicles, servers, base stations, and the like, and transmits and receives various data. As the communication with the outside of the vehicle, for example, the communication unit 22 receives, from the outside, a program for updating software for controlling the operation of the vehicle control system 11, map information, traffic information, information around the vehicle 1, and the like. For example, the communication unit 22 transmits, to the outside, information regarding the vehicle 1 (for example, data indicating the state of the vehicle 1, a recognition result by a recognition unit 73, and the like), information around the vehicle 1, and the like. For example, the communication unit 22 performs communication corresponding to a vehicle emergency call system such as an eCall.

Note that the communication method of the communication unit 22 is not particularly limited. Furthermore, a plurality of communication methods may be used.

As communication with the inside of the vehicle, for example, the communication unit 22 performs wireless communication with in-vehicle equipment by a communication method such as wireless LAN, Bluetooth, NFC, or wireless USB (WUSB). For example, the communication unit 22 performs wired communication with in-vehicle equipment by a communication method such as a universal serial bus (USB), a high-definition multimedia interface (HDMI, registered trademark), or a mobile high-definition link (MHL) via a connection terminal (and, if necessary, a cable) not illustrated.

Here, the in-vehicle equipment is, for example, equipment that is not connected to the communication network 41 in the vehicle. For example, mobile equipment or wearable equipment carried by a passenger such as a driver, information equipment brought into the vehicle and temporarily installed, the like are assumed.

For example, the communication unit 22 communicates with a server and the like existing on an external network (for example, the Internet, a cloud network, or a company-specific network) via a base station or an access point by a wireless communication method such as the fourth generation mobile communication system (4G), the fifth generation mobile communication system (5G), long term evolution (LTE), or dedicated short range communications (DSRC).

For example, the communication unit 22 communicates with a terminal (for example, a terminal of a pedestrian or a store, or a machine type communication (MTC) terminal) existing in the vicinity of The subject vehicle using a peer to peer (P2P) technology. For example, the communication unit 22 performs V2X communication. The V2X communication is, for example, vehicle to vehicle communication with another vehicle, vehicle to infrastructure communication with a roadside device and the like, vehicle to home communication, vehicle to pedestrian communication with a terminal and the like carried by a pedestrian, and the like.

For example, the communication unit 22 receives an electromagnetic wave transmitted by a vehicle information and communication system (VICS, registered trademark) such as a radio wave beacon, an optical beacon, or FM multiplex broadcasting.

The map information accumulation unit 23 accumulates a map acquired from the outside and a map created by the vehicle 1. For example, the map information accumulation unit 23 accumulates a three-dimensional highly accurate map, a global map having lower accuracy than the highly accurate map and covering a wide area, and the like.

The highly accurate map is, for example, a dynamic map, a point cloud map, a vector map (also referred to as advanced driver assistance system (ADAS) map), and the like. The dynamic map is, for example, a map including four layers of dynamic information, semi-dynamic information, semi-static information, and static information, and is provided from an external server and the like. The point cloud map is a map including point clouds (point cloud data). The vector map is a map in which information such as a lane and a position of a traffic signal associated with the point cloud map. The point cloud map and the vector map may be provided from, for example, an external server and the like, or may be created by the vehicle 1 as a map for performing matching with a local map described later on the basis of a sensing result by a radar 52, a LiDAR 53, and the like, and may be accumulated in the map information accumulation unit 23. Furthermore, in a case where a highly accurate map is provided from an external server and the like, in order to reduce the communication capacity, map data of, for example, several hundred meters square regarding a planned path on which the vehicle 1 travels from now on is acquired from the server and the like.

The GNSS reception unit 24 receives a GNSS signal from a GNSS satellite, and supplies the GNSS signal to the travel assistance/automated driving control unit 29.

The external recognition sensor 25 includes various sensors used for recognition of a situation outside the vehicle 1, and supplies sensor data from each sensor to each unit of the vehicle control system 11. The type and number of sensors included in the external recognition sensor 25 are discretionary.

For example, the external recognition sensor 25 includes a camera 51, the radar 52, the light detection and ranging, laser imaging detection and ranging (LiDAR) 53, and an ultrasonic sensor 54. The number of the camera 51, the radar 52, the LiDAR 53, and the ultrasonic sensor 54 is discretionary, and an example of a sensing region of each sensor will be described later.

Note that as the camera 51, for example, a camera of a discretionary imaging method such as a time of flight (ToF) camera, a stereo camera, a monocular camera, or an infrared camera is used as necessary.

Furthermore, for example, the external recognition sensor 25 includes an environment sensor for detecting weather, meteorological phenomenon, brightness, and the like. The environment sensor includes, for example, a raindrop sensor, a fog sensor, a sunshine sensor, a snow sensor, an illuminance sensor, and the like.

Moreover, for example, the external recognition sensor 25 includes a microphone used for detection of sound around the vehicle 1, a position of a sound source, and the like.

The in-vehicle sensor 26 includes various sensors for detecting information inside the vehicle, and supplies sensor data from each sensor to each unit of the vehicle control system 11. The type and number of sensors included in the in-vehicle sensor 26 are discretionary.

For example, the in-vehicle sensor 26 includes a camera, a radar, a seating sensor, a steering wheel sensor, a microphone, a biological sensor, and the like. As the camera, for example, a camera of any imaging method such as a ToF camera, a stereo camera, a monocular camera, an infrared camera, and the like can be used. The biological sensor is provided, for example, in a seat, a steering wheel, and the like, and detects various kinds of biological information of a passenger such as a driver.

The vehicle sensor 27 includes various sensors for detecting the state of the vehicle 1, and supplies sensor data from each sensor to each unit of the vehicle control system 11. The type and number of sensors included in the vehicle sensor 27 are discretionary.

For example, the vehicle sensor 27 includes a speed sensor, an acceleration sensor, an angular velocity sensor (gyro sensor), and an inertial measurement unit (IMU). For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the rotation speed of the engine or the motor, an air pressure sensor that detects the air pressure of the tire, a slip rate sensor that detects the slip rate of the tire, and a wheel speed sensor that detects the rotation speed of the wheel. For example, the vehicle sensor 27 includes a battery sensor that detects a remaining amount and temperature of the battery, and an impact sensor that detects an external impact.

The recording unit 28 includes, for example, a read only memory (ROM), a random access memory (RAM), a magnetic storage device such as a hard disc drive (HDD), a semiconductor storage device, an optical storage device, a magneto-optical storage device, and the like. The recording unit 28 records various programs, data, and the like used by each unit of the vehicle control system 11. For example, the recording unit 28 records a rosbag file including a message transmitted and received by a robot operating system (ROS) in which an application program related to automated driving operates. For example, the recording unit 28 includes an event data recorder (EDR) and a data storage system for automated driving (DSSAD), and records information of the vehicle 1 before and after an event such as an accident.

The travel assistance/automated driving control unit 29 controls travel assistance and automated driving of The vehicle 1. For example, the travel assistance/automated driving control unit 29 includes an analysis unit 61, a behavior planning unit 62, and an operation control unit 63.

The analysis unit 61 performs analysis processing of the situation of the vehicle 1 and the surroundings. The analysis unit 61 includes a self-position estimation unit 71, a sensor fusion unit 72, and a recognition unit 73.

The self-position estimation unit 71 estimates the self-position of the vehicle 1 on the basis of the sensor data from the external recognition sensor 25 and the highly accurate map accumulated in the map information accumulation unit 23, For example, the self-position estimation unit 71 generates a local map on the basis of sensor data from the external recognition sensor 25, and estimates the self-position of the vehicle 1 by matching the local map with the highly accurate map. The position of the vehicle 1 is based on, for example, the center of a rear wheel pair axle.

The local map is, for example, a three-dimensional highly accurate map created using a technology such as simultaneous localization and mapping (SLAM), an occupancy grid map, and the like. The three-dimensional highly accurate map is, for example, the above-described point cloud map and the like. The occupancy grid map is a map in which a three-dimensional or two-dimensional space around the vehicle 1 is divided into grids of a predetermined size to indicate an occupancy state of an object in units of grids. The occupancy state of an object is indicated by, for example, the presence or absence or existence probability of the object. The local map is also used for detection processing and recognition processing of a situation outside the vehicle 1 by the recognition unit 73, for example.

Note that the self-position estimation unit 71 may estimate the self-position of the vehicle 1 on the basis of a GLASS signal and sensor data from the vehicle sensor 27.

The sensor fusion unit 72 performs sensor fusion processing of obtaining new information by combining a plurality of different types of sensor data (for example, image data supplied from the camera 51 and sensor data supplied from the radar 52). Methods for combining different types of sensor data include integration, fusion, association, and the like.

The recognition unit 73 performs detection processing and recognition processing of the situation outside the vehicle 1.

For example, the recognition unit 73 performs detection processing and recognition processing of the situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The detection processing of an object is, for example, processing of detecting the presence or absence, size, shape, position, motion, and the like of the object. The recognition processing of an object is, for example, processing of recognizing an attribute such as a type of the object or identifying a specific object. However, the detection processing and the recognition processing are not necessarily clearly divided, and may overlap.

For example, the recognition unit 73 detects an object around the vehicle 1 by performing clustering for classifying point clouds based on sensor data such as LiDAR or radar for each cluster of point clouds. Therefore, the presence or absence, size, shape, and position of the object around the vehicle 1 are detected.

For example, the recognition unit 73 detects the motion of the object around the vehicle 1 by performing tracking that follows the motion of the cluster of the point cloud classified by clustering. Therefore, the speed and the traveling direction (movement vector) of the object around the vehicle 1 are detected.

For example, the recognition unit 73 recognizes the type of the object around the vehicle 1 by performing object recognition processing such as semantic segmentation on the image data supplied from the camera 51.

Note that as the object to be detected or recognized, for example, a vehicle, a human, a bicycle, an obstacle, a structure, a road, a traffic light, a traffic sign, a road sign, and the like are assumed.

For example, the recognition unit 73 performs recognition processing of traffic rules around the vehicle 1 on the basis of the map accumulated in the map information accumulation unit 23, the estimation result of the self-position, and the recognition result of the object around the vehicle 1. By this processing, for example, the position and the state of a traffic signal, the content of a traffic sign and a road sign, the content of traffic regulation, a travelable lane, and the like are recognized.

For example, the recognition unit 73 performs recognition processing of the environment around the vehicle 1. As the surrounding environment to be recognized, for example, weather, temperature, humidity, brightness, a state of a road surface, and the like are assumed.

The behavior planning unit 62 creates a behavior plan of the vehicle 1. For example, the behavior planning unit 62 creates a behavior plan by performing processing of path planning and path following.

Note that the global path planning is processing of planning a rough path from the start to the goal. This path planning includes processing of local path planning that is called a trajectory planning and that enables safe and smooth traveling in the vicinity of the vehicle 1 in consideration of the motion characteristics of the vehicle 1 in the path planned by the path plan.

The path following is processing of planning an operation for safely and accurately traveling a path planned by a path planning within a planned time. For example, the target speed and the target angular velocity of the vehicle 1 are calculated.

The operation control unit 63 controls the operation of the vehicle 1 in order to achieve the behavior plan created by the behavior planning unit 62.

For example, the operation control unit 63 controls a steering control unit 81, a brake control unit 82, and a drive control unit 83 to perform acceleration/deceleration control and direction control such that the vehicle 1 travels on the trajectory calculated by the trajectory plan. For example, the operation control unit 63 performs cooperative control for the purpose of implementing the functions of the ADAS such as collision avoidance or impact mitigation, follow-up traveling, vehicle speed maintaining traveling, collision warning of the subject vehicle, lane departure warning of the subject vehicle, and the like. For example, the operation control unit 63 performs cooperative control for the purpose of automated driving and the like in which the vehicle autonomously travels without depending on the operation of the driver.

The DMS 30 performs authentication processing of a driver, recognition processing of a driver state, and the like on the basis of sensor data from the in-vehicle sensor 26, input data input to the HMI 31, and the like. As the state of the driver to be recognized, for example, a physical condition, an arousal level, a concentration level, a fatigue level, a line-of-sight direction, a drunkenness level, a driving operation, a posture, and the like are assumed.

Note that the DMS 30 may perform authentication processing of a passenger other than the driver and recognition processing of the state of the passenger. Furthermore, for example, the DFS 30 may perform recognition processing of the situation inside the vehicle on the basis of sensor data from the in-vehicle sensor 26. As the situation inside the vehicle to be recognized, for example, temperature, humidity, brightness, odor, and the like are assumed.

The HMI 31 is used for inputting various data, instructions, and the like, generates an input signal on the basis of the input data, instructions, and the like, and supplies the input signal to each unit of the vehicle control system 11. For example, the HMI 31 includes an operation device such as a touchscreen, a button, a microphone, a switch, and a lever, an operation device that enables inputting by a method other than manual operation by voice, gesture, and the like. Note that the HMI 31 may be, for example, a remote control apparatus using infrared rays or other radio waves, or external connection equipment such as mobile equipment or wearable equipment compatible with the operation of the vehicle control system 11.

Furthermore, the HMI 31 performs output control of controlling generation and output of visual information, auditory information, and tactile information to the passenger or the outside of the vehicle, as well as output content, output timing, an output method, and the like. The visual information is, for example, information indicated by an image or light such as an operation screen, a state display of the vehicle 1, a warning display, or a monitor image indicating the situation around the vehicle 1. The auditory information is, for example, information indicated by voice such as guidance, a warning sound, a warning message, and the like. The tactile information is, for example, information given to the tactile sense of the passenger by force, vibration, motion, and the like.

As a device that outputs visual information, for example, a display device, a projector, a navigation apparatus, an instrument panel, a camera monitoring system (CMS), an electronic mirror, a lamp, and the like are assumed. The display device may be an apparatus that displays visual information in the field of view of the passenger, such as a head-up display, a transmissive display, a wearable device having an augmented reality (AR) function, and the like, in addition co an apparatus having a normal display.

As a device that outputs auditory information, for example, an audio speaker, a headphone, an earphone, and the like are assumed.

As a device that outputs tactile information, for example, a haptics element using haptics technology and the like are assumed. The haptics element is provided on, for example, the steering wheel, the seat, and the like.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of the state of a steering system of the vehicle 1. The steering system includes, for example, a steering mechanism including a steering wheel and the like, an electric power steering, and the like. The steering control unit 81 includes, for example, a control unit such as an ECU that controls the steering system, an actuator that drives the steering system, and the like.

The brake control unit 82 detects and controls the state of a brake system of the vehicle 1. The brake system includes, for example, a brake mechanism including a brake pedal, an antilock brake system (ABS), and the like. The brake control unit 82 includes, for example, a control unit such as an ECU that controls the brake system, an actuator that drives the brake system, and the like.

The drive control unit 83 detects and controls the state of a drive system of the vehicle 1. The drive system includes, for example, an accelerator pedal, a driving force generation apparatus for generating a driving force such as an internal combustion engine, a driving motor, and the like, a driving force transmission mechanism for transmitting the driving force to the wheels, and the like. The drive control unit 83 includes, for example, a control unit such as an ECU that controls the drive system, an actuator that drives the drive system, and the like.

The body system control unit 84 detects and controls the state of a body system of the vehicle 1. The body system includes, for example, a keyless entry system, a smart key system, a power window device, a power seat, an air conditioning apparatus, an airbag, a seat belt, a shift lever, and the like. The body system control unit 84 includes, for example, a control unit such as an ECU that controls the body system, an actuator that drives the body system, and the like.

The light control unit 85 detects and controls states of various lights of the vehicle 1. As the lights to be controlled, for example, a headlight, a backlight, a fog light, a turn signal, a brake light, a projection, a display of a bumper, and the like are assumed. The light control unit 85 includes a control unit such as an ECU that controls light, an actuator that drives light, and the like.

The horn control unit 86 detects and controls the state of a car horn of the vehicle 1. The horn control unit 86 includes, for example, a control unit such as an ECU that controls the car horn, an actuator that drives the car horn, and the like.

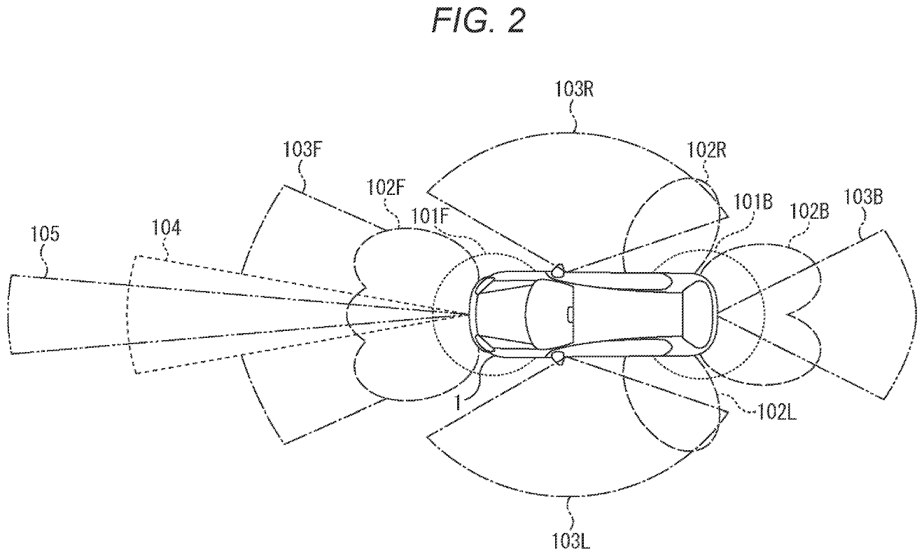

FIG. 2 is a view illustrating an example of a sensing region by the camera 51, the radar 52, the LiDAR 53, and the ultrasonic sensor 54 of the external recognition sensor 25 in FIG. 1.

A sensing region 101F and a sensing region 101B illustrate examples of the sensing region of the ultrasonic sensor 54. The sensing region 101F covers the periphery of the front end of the vehicle 1. The sensing region 101B covers The periphery of the rear end of the vehicle 1.

The sensing results in the sensing region 101F and the sensing region 101B are used, for example, for parking assistance of the vehicle 1.

Sensing regions 102F to 102B illustrate examples of sensing regions of the radar 52 for a short distance or a middle distance. The sensing region 102F covers a position farther than the sensing region 101F in front of the vehicle 1. The sensing region 102B covers a position farther than the sensing region 101B behind the vehicle 1. The sensing region 102L covers the periphery behind the left side surface of the vehicle 1. The sensing region 102R covers the periphery behind the right side surface of the vehicle 1.

The sensing result in the sensing region 102F is used, for example, for detection of a vehicle, a pedestrian, and the like existing in front of the vehicle 1. The sensing result in the sensing region 102B is used, for example, for a collision prevention function and the like behind the vehicle 1. The sensing results in the sensing region 102L and the sensing region 102R are used, for example, for detection of an object in a blind spot on the side of the vehicle 1.

Sensing regions 103F to 103B illustrate examples of sensing regions by the camera 51. The sensing region. 103F covers a position farther than the sensing region 102F in front of the vehicle 1. The sensing region 103B covers a position farther than the sensing region 102B behind the vehicle 1. The sensing region 103L covers the periphery of the left side surface of the vehicle 1. The sensing region 103R covers the periphery of the right side surface of the vehicle 1.

The sensing result in the sensing region 103F is used, for example, for recognition of a traffic light and a traffic sign, a lane departure prevention assist system, and the like. The sensing result in the sensing region 103B is used, for example, for parking assistance, a surround view system, and the like. The sensing results in the sensing region 103L and the sensing region 103R are used, for example, in a surround view system and the like.

A sensing region 104 illustrates an example of a sensing region of the LiDAR 53. The sensing region 104 covers a position farther than the sensing region 103F in front of the vehicle 1. On the other hand, the sensing region 104 has a narrower range in the left-right direction than that of the sensing region 103F.

The sensing result in the sensing region 104 is used, for example, for emergency, braking, collision avoidance, pedestrian detection, and the like.

A sensing region 105 illustrates an example of the sensing region of a radar 52 for a long range. The sensing region 105 covers a position farther than the sensing region 104 in front of the vehicle 1. On the other hand, the sensing region 105 has a narrower range in the left-right direction than that of the sensing region 104.

The sensing result in the sensing region 105 is used, for example, for adaptive cruise control (ACC).

Note that the sensing region of each sensor may have various configurations other than those in FIG. 2.

Specifically, the ultrasonic sensor 54 may also sense the side of the vehicle 1, or the LiDAR 53 may sense behind the vehicle 1.

### 2. Evaluation of Distance Information of Recognition System

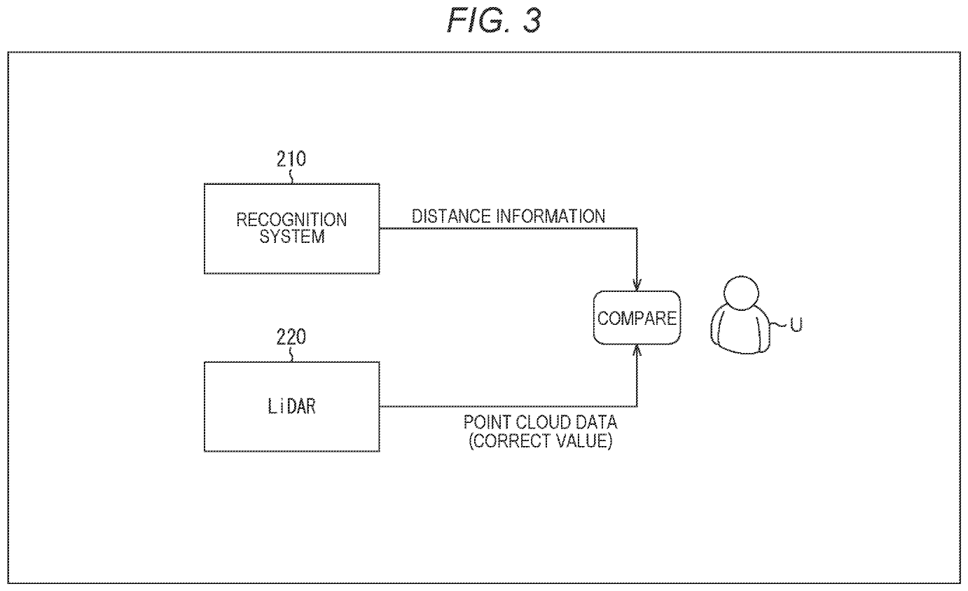

For example, as illustrated in FIG. 3, as a method of evaluating distance information output by a recognition system 210 that recognizes an object around the vehicle 1 by performing the sensor fusion processing described above, it is conceivable to compare and evaluate the point cloud data of a LiDAR 220 as a correct value. However, in a case where a user U visually compares the distance information of the recognition system 210 with the LiDAR point cloud data frame by frame, it takes a huge amount of time.

Therefore, in the following, a configuration in which the distance information of the recognition system and the LiDAR point cloud data are automatically compared will be described.

### 3. Configuration and Operation of Evaluation Apparatus

(Configuration of Evaluation Apparatus)

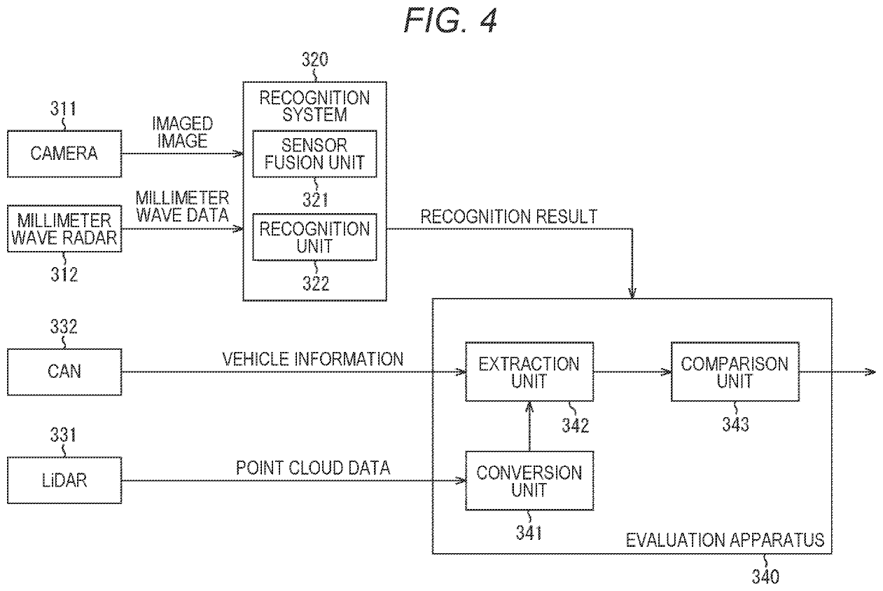

FIG. 4 is a block diagram illustrating the configuration of an evaluation apparatus that evaluates distance information of the recognition system as described above.

FIG. 4 illustrates a recognition system 320 and an evaluation apparatus 340.

The recognition system 320 recognizes an object around the vehicle 1 on the basis of an imaged image obtained by the camera 311 and millimeter wave data obtained by the millimeter wave radar 312. The camera 311 and the millimeter wave radar 312 correspond to the camera 51 and the radar 52 in FIG. 1, respectively.

The recognition system 320 includes a sensor fusion unit 321 and a recognition unit 322.

The sensor fusion unit 321 corresponds to the sensor fusion unit 72 in FIG. 1, and performs sensor fusion processing using the imaged image from the camera 311 and the millimeter wave data from the millimeter wave radar 312.

The recognition unit 322 corresponds to the recognition unit 73 in FIG. 1, and performs recognition processing (detection processing) of an object around the vehicle 1 on the basis of a processing result of the sensor fusion processing by the sensor fusion unit 321.

The recognition result of the object around the vehicle 1 is output by the sensor fusion processing by the sensor fusion unit 321 and the recognition processing by the recognition unit 322.

The recognition result of the object obtained while the vehicle 1 is traveling is recorded as a data log and input to the evaluation apparatus 340. Note that the recognition result of the object includes distance information indicating the distance to the object around the vehicle 1, object information indicating the type and attribute of the object, speed information indicating the speed of the object, and the like.

Similarly, while the vehicle 1 is traveling, point cloud data is obtained by a LiDAR 331 serving as a rangefinding sensor in the present embodiment, and moreover, various vehicle information regarding the vehicle 1 is obtained via a CAN 332. The LiDAR 331 and the CAN 332 correspond to the LiDAR 53 and the communication network 41 in FIG. 1, respectively. The point cloud data and vehicle information obtained while the vehicle 1 is traveling are also recorded as a data log and input to the evaluation apparatus 340.

The evaluation apparatus 340 includes a conversion unit 341, an extraction unit 342, and a comparison unit 343.

The conversion unit 341 converts the point cloud data that is the data in an xyz three-dimensional coordinate system obtained by the LiDAR 331 into a camera coordinate system of the camera 311, and supplies the converted point cloud data to the extraction unit 342.

By using the recognition result from the recognition system 320 and the point cloud data from the conversion unit 341, the extraction unit 342 extracts, among point cloud data, the point cloud data corresponding to an object region including the object in the imaged image on the basis of the object recognized in the imaged image. In other words, the extraction unit 342 performs clustering on the point cloud data corresponding to the recognized object among the point cloud data.

Specifically, the extraction unit 342 associates the imaged image including a rectangular frame indicating the object region of the recognized object supplied from the recognition system 320 as the recognition result with the point cloud data from the conversion unit 341, and extracts the point cloud data existing in the rectangular frame. At this time, the extraction unit 342 sets an extraction condition of the point cloud data on the basis of the recognized object, and extracts the point cloud data existing in the rectangular frame on the basis of the extraction condition. The extracted point cloud data is supplied to the comparison unit 343 as point cloud data corresponding to the object that is the evaluation target for the distance information.

With the point cloud data from the extraction unit 342 as a correct value, the comparison unit 343 compares the point cloud data with the distance information included in the recognition result from the recognition system 320. Specifically, it is determined whether or not a difference between the distance information from the recognition system 320 and a correct value (point cloud data) falls within a predetermined reference value. The comparison result is output as an evaluation result of the distance information from the recognition system 320. Note that the accuracy of the correct value can be further enhanced by using the mode of the point cloud data existing in the rectangular frame as the point cloud data used as the correct value.

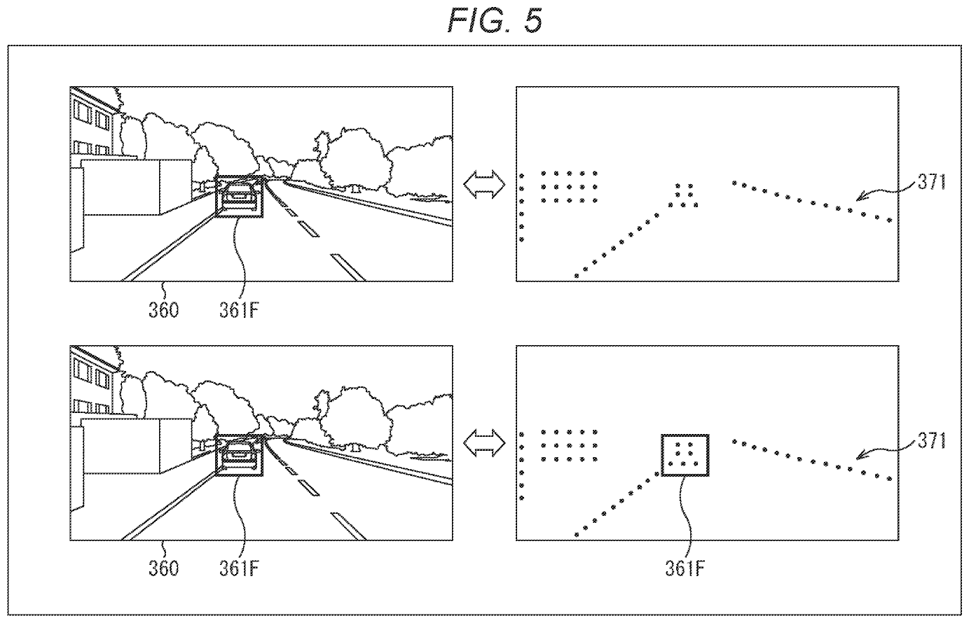

Conventionally, for example, as illustrated in the upper part of FIG. 5, it has been visually confirmed as to which point cloud data 371 of point cloud data 371 obtained by LIDAR corresponds to a rectangular frame 361F indicating the vehicle recognized in an imaged image 360.

On the other hand, according to the evaluation apparatus 340, as illustrated in the lower part of FIG. 5, the point cloud data 371 corresponding to the rectangular frame 361F indicating the vehicle recognized in the imaged image 360 is extracted from the point cloud data 371 obtained by the LiDAR. Therefore, it is possible to narrow down the point cloud data corresponding to the evaluation target, and it becomes possible to perform comparison between the distance information of the recognition system and the LiDAR point cloud data accurately with a low load.

### Example of Extraction of Point Cloud Data

As described above, the extraction unit 342 can set the extraction condition (clustering condition) of the point cloud data on the basis of the recognized object, for example, according to the state of the recognized object.

### Example 1

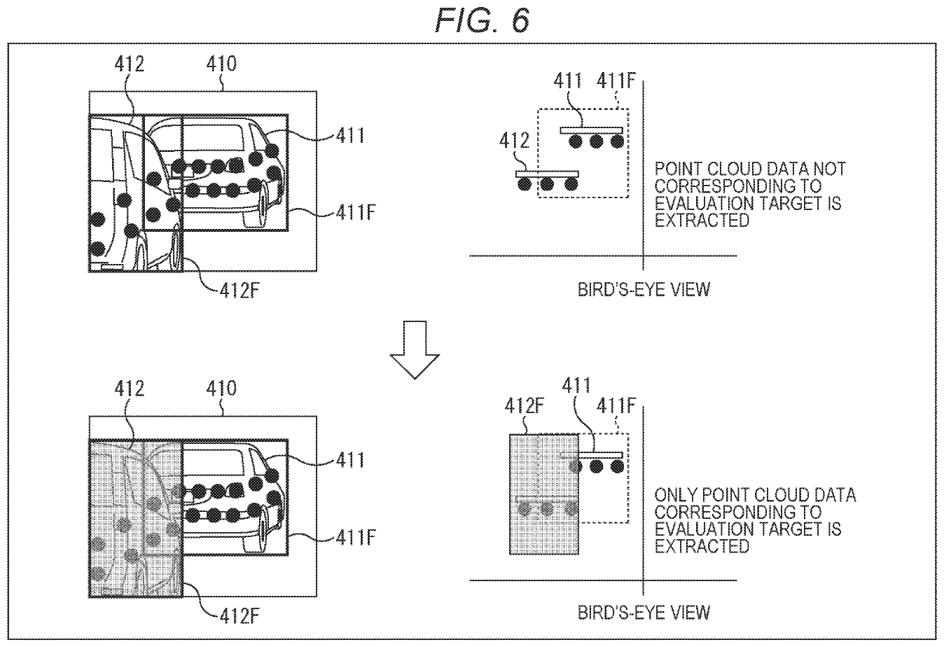

As illustrated in the upper left side of FIG. 6, in a case where another vehicle 412 exists closer to the subject vehicle than to a vehicle 411 that is an evaluation target in an imaged image 410, a rectangular frame 411F for the vehicle 411 overlaps with a rectangular frame 412F for the other vehicle 412. In a case where point cloud data existing in the rectangular frame 411F is extracted in this state, point cloud data that does not correspond to the evaluation target is extracted as illustrated in a bird's-eye view on the upper right side of FIG. 6. In the bird's-eye view as in the upper right side of FIG. 6, the point cloud data on the three-dimensional coordinates obtained by the LiDAR 331 is illustrated together with the corresponding object.

Therefore, as illustrated in the lower left side of FIG. 6, by masking the region corresponding to the rectangular frame 412F for the other vehicle 412, the extraction unit 342 excludes the point cloud data corresponding to the region overlapping the rectangular frame 412F in the rectangular frame 411F from the extraction target. Therefore, as illustrated in the bird's-eye view on the right side of the lower part of FIG. 6, only the point cloud data corresponding to the evaluation target can be extracted.

Note that the rectangular frame is defined by, for example, the width and height of a rectangular frame with the coordinates of the upper left vertex of the rectangular frame as a reference point, and whether or not the rectangular frames overlap each other is determined on the basis of the reference point, the width, and the height of each rectangular frame.

### Example 2

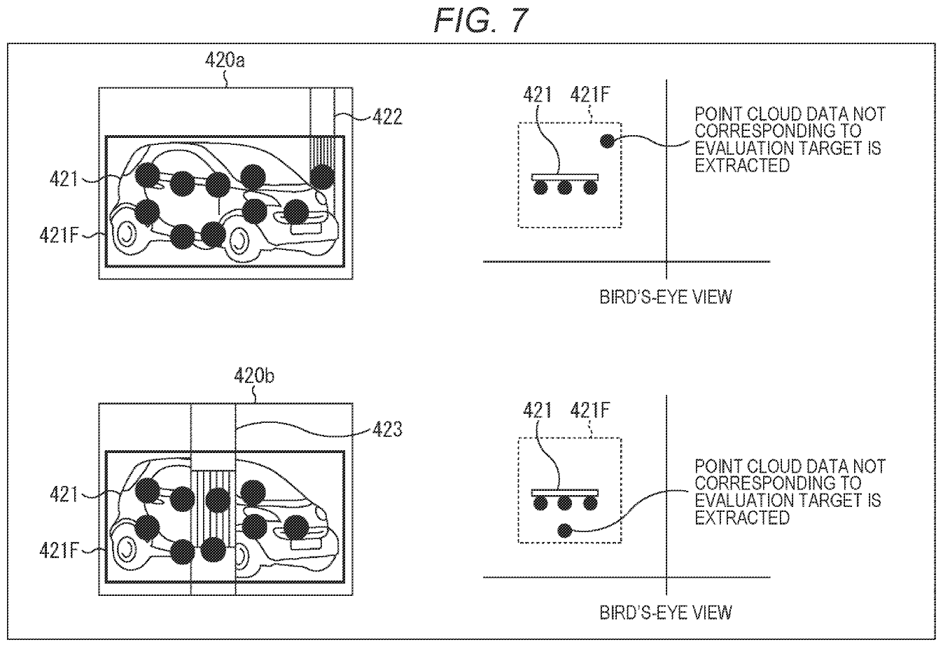

As illustrated in the upper left side of FIG. 7, in a case where an obstacle 422 such as a utility pole exists behind the vehicle 421 that is the evaluation target in an imaged image 420a, when point cloud data existing in a rectangular frame 421F of the vehicle 421 is extracted, point cloud data that does not correspond to the evaluation target is extracted as a bird's-eye view in the upper right side of FIG. 7.

Similarly, as illustrated in the lower left side of FIG. 7, in a case where an obstacle 423 such as a utility pole exists closer to the subject vehicle than to the vehicle 421 that is the evaluation target in an imaged image 420b, when point cloud data existing in a rectangular frame 421F of the vehicle 421 is extracted, point cloud data that does not correspond to the evaluation target is extracted as a bird's-eye view in the lower right side of FIG. 7.

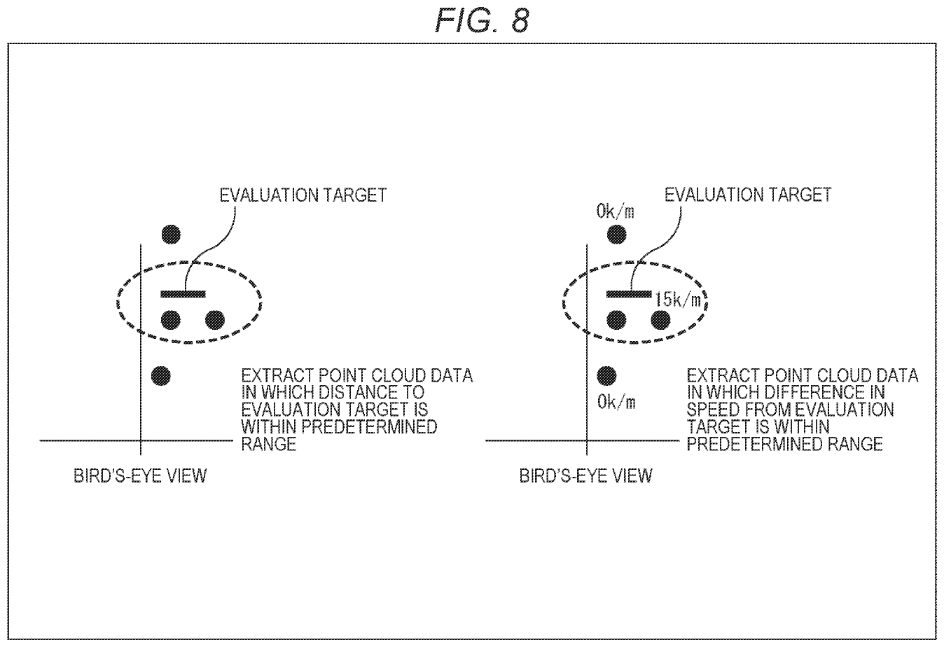

On the other hand, as illustrated on the left side of FIG. 8, the extraction unit 342 extracts the point cloud data in which the distance to the evaluation target is within a predetermined range by excluding, from the extraction target, the point cloud data in which the distance to the object that is the evaluation target (recognized object) is larger than a predetermined distance threshold. Note that the distance to the evaluation target is acquired from distance information included in the recognition result output by the recognition system 320.

At this time, the extraction unit 342 sets the distance threshold according to the object that is the evaluation target (the type of the object). The distance threshold is set to a larger value as the moving speed of the object that is the evaluation target is higher, for example. Note that the type of the object that is the evaluation target is also acquired from the object information included in the recognition result output by the recognition system 320.

For example, in a case where the evaluation target is a vehicle, by setting the distance threshold to 1.5 m, point cloud data in which the distance to the vehicle is larger than 1.5 m is excluded from the extraction target. Furthermore, in a case where the evaluation target is a motorcycle, by setting the distance threshold to 1 m, point cloud data in which the distance to the motorcycle is larger than 1 m is excluded from the extraction target. Moreover, in a case where the evaluation target is a bicycle or a pedestrian, by setting the distance threshold to 50 cm, point cloud data in which the distance to the bicycle or the pedestrian is larger than 50 cm is excluded from the extraction target.

Note that the extraction unit 342 may change the set distance threshold according to the moving speed (vehicle speed) of the vehicle 1 on which the camera 311 and the millimeter wave radar 312 are mounted. In general, the inter-vehicle distance between vehicles increases during high-speed traveling, and the inter-vehicle distance decreases during low-speed traveling. Therefore, when the vehicle 1 is traveling at a high speed, the distance threshold is changed to a larger value. For example, in a case where the vehicle 1 is traveling at 40 km/h or higher, when the evaluation target is a vehicle, the distance threshold is changed from 1.5 m to 3 m. In a case where the vehicle 1 is traveling at 40 km/h or higher, when the evaluation target is a motorcycle, the distance threshold is changed from 1 in to 2 m. Note that the vehicle speed of the vehicle 1 is acquired from vehicle information obtained via the CAN 332.

### Example 3

Moreover, as illustrated on the right side of FIG. 8, the extraction unit 342 extracts the point cloud data in which the difference in speed from the evaluation target is within a predetermined range by excluding, from the extraction target, the point cloud data in which the difference between the speed of the object (recognized object) that is the evaluation target and the speed calculated on the basis of time-series change in the point cloud data is larger than a predetermined speed threshold. The speed of point cloud data is calculated by a change in the position of the point cloud data in time series. The speed of the evaluation target is acquired from speed information included in the recognition result output by the recognition system 320.

In the example on the right side of FIG. 8, the point cloud data at a speed of 0 km/h existing behind the object that is the evaluation target and the point cloud data at a speed of 0 km/h exists closer to the subject vehicle than to the object that is the evaluation target are excluded from the extraction target, and the point cloud data at a speed of 15 km/h existing in the vicinity of the object that is the evaluation target is extracted.

### Example 4

The extraction unit 342 can also chance the extraction region of point cloud data according to the distance to the object that is the evaluation target, in other words, the size of the object region in the imaged image.

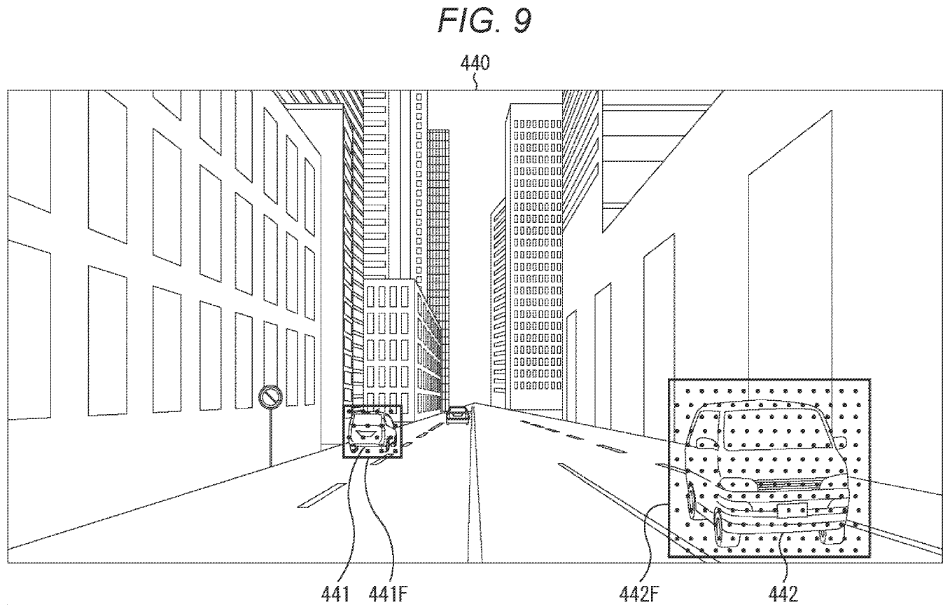

For example, as illustrated in FIG. 9, in an imaged image 440, a rectangular frame 441F for a vehicle 441 positioned at a long distance becomes small, and a rectangular frame 442F for a vehicle 442 positioned at a short distance becomes large. In this case, in the rectangular frame 441F, the number of point cloud data corresponding to the vehicle 441 is small. On the other hand, in the rectangular frame 442F, although the number of point cloud data corresponding to the vehicle 442 is large, many point cloud data corresponding to the background and the road surface are included.

Therefore, in a case where the rectangular frame is larger than a predetermined area, the extraction unit 342 sets only the point cloud data corresponding to the vicinity of the center of the rectangular frame as the extraction target, and in a case where the rectangular frame is smaller than the predetermined area, the extraction unit sets the point cloud data corresponding to the entire rectangular frame as the extraction target.

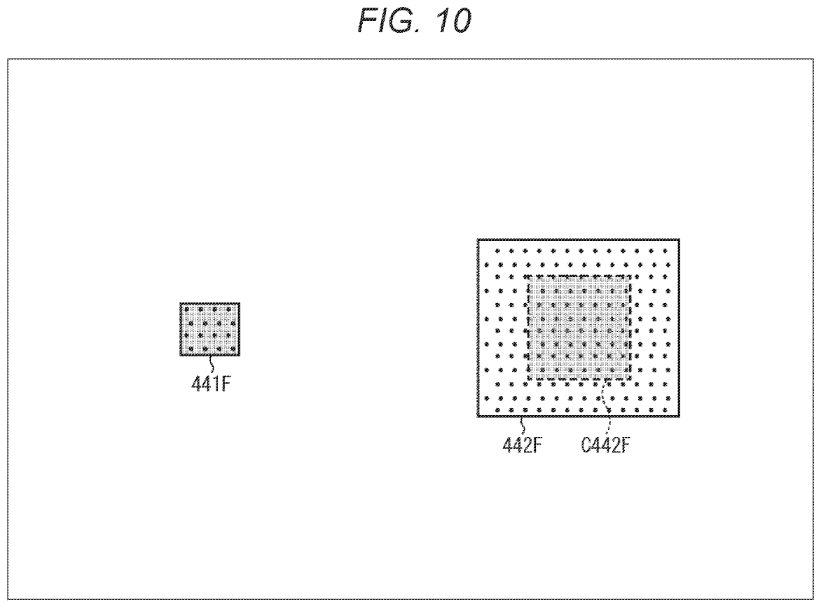

That is, as illustrated in FIG. 10, in the rectangular frame 441F having a small area, the point cloud data corresponding to the entire rectangular frame 441F is extracted. On the other hand, in the rectangular frame 442F having a large area, only the point cloud data corresponding to a region C442F near the center of the rectangular frame 442F is extracted. Therefore, point cloud data corresponding to the background and the road surface can be excluded from the extraction target.

Furthermore, also in a case where the evaluation target is a bicycle, a pedestrian, a motorcycle, and the like, the rectangular frame for these includes many point cloud data corresponding to the background and the road surface. Therefore, in a case where the type of the object acquired from the object information included in the recognition result output by the recognition system 320 is a bicycle, a pedestrian, a motorcycle, and the like, only the point cloud data corresponding to the vicinity of the center of the rectangular frame may be set as the extraction target.

As described above, by setting the extraction condition (clustering condition) of the point cloud data on the basis of the object that is the evaluation target, it is possible to more reliably extract the point cloud data corresponding to the object that is the evaluation target.

(Evaluation Processing of Distance Information)

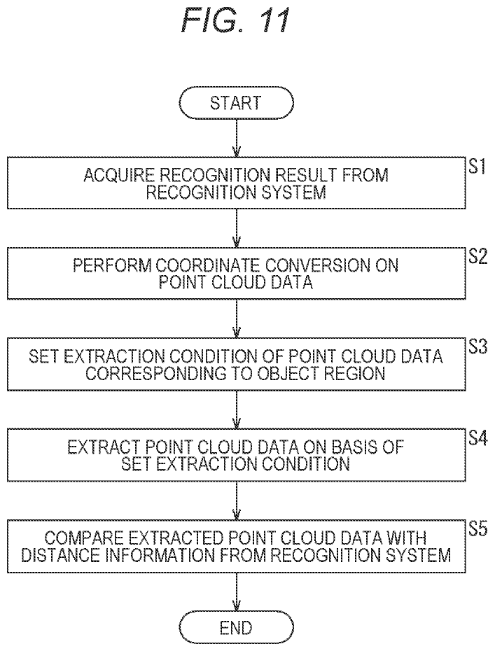

Here, evaluation processing of distance information by the evaluation apparatus 340 will be described with reference to the flowchart of FIG. 11.

In step S1, the extraction unit 342 acquires the recognition result of the object recognized in an imaged image film the recognition system 320.

In step S2, the conversion unit 341 performs coordinate conversion on the point cloud data obtained by the LiDAR 331.

In step S3, the extraction unit 342 sets, on the basis of the object, an extraction condition of the point cloud data corresponding to the object region of the object recognized in the imaged image by the recognition system 320 among the point cloud data converted into the camera coordinate system.

In step S4, the extraction unit 342 extracts the point cloud data corresponding to the object region for the recognized object on the basis of the set extraction condition.

In step S6, with the point cloud data extracted by the extraction unit 342 as a correct value, the comparison unit 343 compares the point cloud data with the distance information included in the recognition result from the recognition system 320. The comparison result is output as an evaluation result of the distance information from the recognition system 320.

According to the above processing, in the evaluation of the distance information from the recognition system 320, it is possible to narrow down the point cloud data corresponding to the evaluation target, and it becomes possible to perform comparison between the distance information of the recognition system and the LiDAR point cloud data accurately with a low load.

(Extraction Condition Setting Processing of Point Cloud Data)

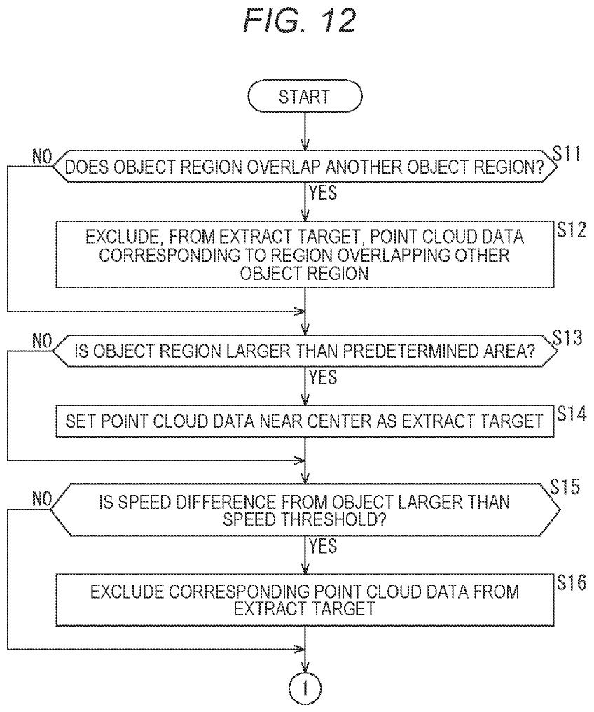

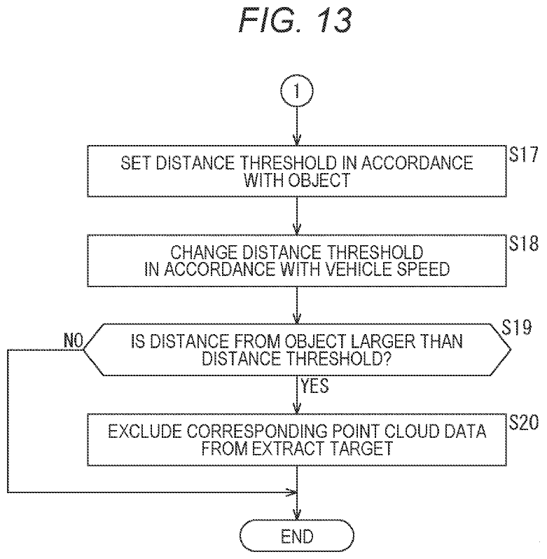

Next, extraction condition setting processing of point cloud data executed in step S3 of the evaluation processing of distance information described above will be described with reference to FIGS. 12 and 13. This processing is started in a state where the point cloud data corresponding to the object region of the recognized object (object that is the evaluation target) in the point cloud data is specified.

In step S11, the extraction unit 342 determines whether or not the object region of the recognized object (object that is the evaluation target) overlaps another object region for another object.

In a case where it is determined that the object region overlaps with another object region, the process proceeds to step S12, and the extraction unit 342 excludes, from the extraction target, the point cloud data corresponding to the region overlapping with another object region as described with reference to FIG. 6. Thereafter, the process proceeds to step S13.

On the other hand, in a case where it is determined than the object region does not overlap with another object region, step S12 is skipped, and the process proceeds to step S13.

In step S13, the extraction unit 342 determines whether or not the object region is larger than a predetermined area.

In a case where it is determined that the object region is larger than the predetermined area, the process proceeds to step S14, and the extraction unit 342 sets the point cloud data near the center of the object region as the extraction target as described with reference to FIGS. 9 and 10. Thereafter, the process proceeds to step S15.

On the other hand, in a case where it is determined that the object region is not larger than the predetermined area, that is, when the object region is smaller than the predetermined area, step S14 is skipped, and the process proceeds to step 315.

In step S15, the extraction unit 342 determines whether or not a speed difference from the recognized object is larger than a speed threshold for each of the point cloud data corresponding to the object region.

In a case where it is determined that the speed difference from the recognized object is larger than the speed threshold, the process proceeds to step S16, and the extraction unit 342 excludes the corresponding point cloud data from the extraction target as described with reference to FIG. 8. Thereafter, the process proceeds to step S17 in FIG. 13.

On the other hand, in a case where it is determined than the speed difference from the recognized object is larger than the speed threshold, that is, an a case where the speed difference from the recognized object is smaller than the speed threshold, step S16 is skipped, and the process proceeds to step S17.

In step S17, the extraction unit 342 sets the distance threshold according to the recognized object (the type of the object) acquired from the object information included in the recognition result.

Next, in step S18, the extraction unit 342 changes the set distance threshold according to the vehicle speed of the vehicle 1 acquired from the vehicle information.

Then, in step S19, the extraction unit 342 determines whether or not the distance to the recognized object is larger than the distance threshold for each of the point cloud data corresponding to the object region.

In a case where is determined that the distance to the recognized object is larger than the distance threshold, the process proceeds to step S20, and the extraction unit 342 excludes the corresponding point cloud data from the extraction target as described with reference to FIG. 8. The extraction condition setting processing of the point cloud data ends.

On the other hand, in a case where it is determined that the distance to the recognized object is larger than the distance threshold, that is, in a case where the distance to the recognized object is smaller than the distance threshold, step S20 is skipped, and the extraction condition setting processing of the point cloud data ends.

According to the above processing, since the extraction condition (clustering condition) of the point cloud data is set according to the state of the object that is the evaluation target, it is possible to more reliably extract the point cloud data corresponding to the object that is the evaluation target. As a result, it is possible to evaluate distance information more accurately, and eventually it becomes possible to obtain the distance to the object more accurately.

### 4. Modification of Point Cloud Data Extraction

Hereinafter, a modification of point cloud data extraction will be described.

### Modification 1

Normally, in a case where the vehicle travels forward at a certain speed, the appearance of an object moving at a speed different from that of the vehicle among objects around the vehicle changes. In this case, the point cloud data or corresponding to the object also changes according to the change in the appearance of the object around the vehicle.

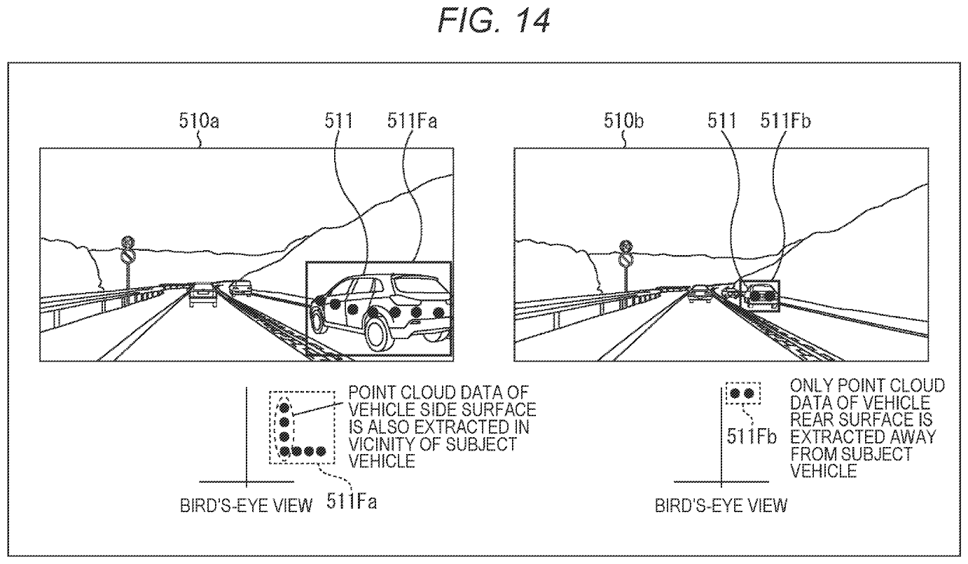

For example, as illustrated in FIG. 14, it is assumed that a vehicle 511 traveling in a lane adjacent to a lane in which the subject vehicle travels is recognized in imaged images 510a and 510b imaged while the subject vehicle is traveling on a road having two lanes on each side. In the imaged image 510a, the vehicle 511 travels in the vicinity of the subject vehicle in the adjacent lane, and in the imaged image 510b, the vehicle 511 travels in the adjacent lane at a position away, forward from the subject vehicle.

In a case where the vehicle 511 is traveling in the vicinity of the subject vehicle as in the imaged image 510a, as the point cloud data corresponding to a rectangular region 511Fa for the vehicle 511, not only the point cloud data of the rear surface of the vehicle 511 but also many point cloud data of the side surface of the vehicle 511 are extracted.

On the other hand, in a case where the vehicle 511 is traveling away from the subject vehicle as in the imaged image 510b, only the point cloud data of the rear surface of the vehicle 511 is extracted as the point cloud data corresponding to a rectangular region 511Fb for the vehicle 511.

In a case where the point cloud data of the side surface of the vehicle 511 is included in the extracted point cloud data as in the imaged image 510a, there is a possibility that an accurate distance to the vehicle 511 cannot be obtained.

Therefore, in a case where the vehicle 511 is traveling in the vicinity of the subject vehicle, only the point cloud data of the rear surface of the vehicle 511 is the extraction target, and the point cloud data of the side surface of the vehicle 511 is excluded from the extraction target.

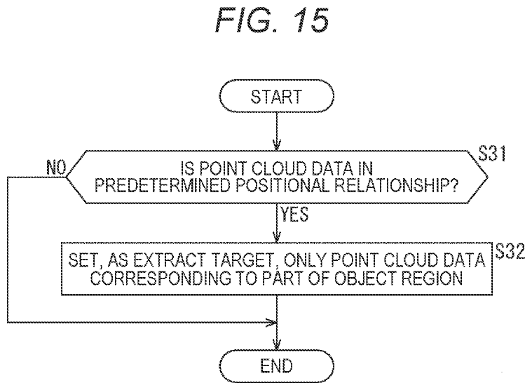

For example, in the extraction condition setting processing of point cloud data, the processing illustrated in the flowchart of FIG. 15 is executed.

In step S31, the extraction unit 342 determines whether or not the point cloud data is in a predetermined positional relationship.

In a case where it is determined that the point cloud data is in the predetermined positional relationship, the process proceeds to step S32, and the extraction unit 342 sets only the point cloud data corresponding to a part of the object region as the extraction target.

Specifically, in a case where a region of an adjacent lane in the vicinity of the subject vehicle is set, and point cloud data corresponding to the object region is arranged so as to indicate an object having a size of, for example, 5 m in the depth direction and 3 m in the horizontal direction in the region of the adjacent lane, it is regarded that the vehicle is traveling in the vicinity of the subject vehicle, and only the point cloud data corresponding to the horizontal direction (point cloud data of the vehicle rear surface) is extracted.

On the other hand, in a case where it is determined that the point cloud data is not in the predetermined positional relationship, step S32 skipped, and the point cloud data corresponding to the entire object regions is set as the extraction target.

As described above, in a case where the vehicle is traveling in the vicinity of the subject vehicle, only the point cloud data of the rear surface of the vehicle can be set as the extraction target.

Note that in a case where, other than this, general clustering processing of the point cloud data corresponding to the object region is executed and the point cloud data continuous in an L shape in the depth direction and the horizontal direction is extracted, it is regarded that the vehicle is traveling in the vicinity of the subject vehicle, and only the point cloud data of the rear surface of the vehicle may be extracted. Furthermore, in a case where the variance of the distance indicated by the point cloud data corresponding to the object region is larger than a predetermined threshold, it is regarded that the vehicle is traveling in the vicinity of the subject vehicle, and only the point cloud data of the rear surface of the vehicle may be extracted.

### Modification 2

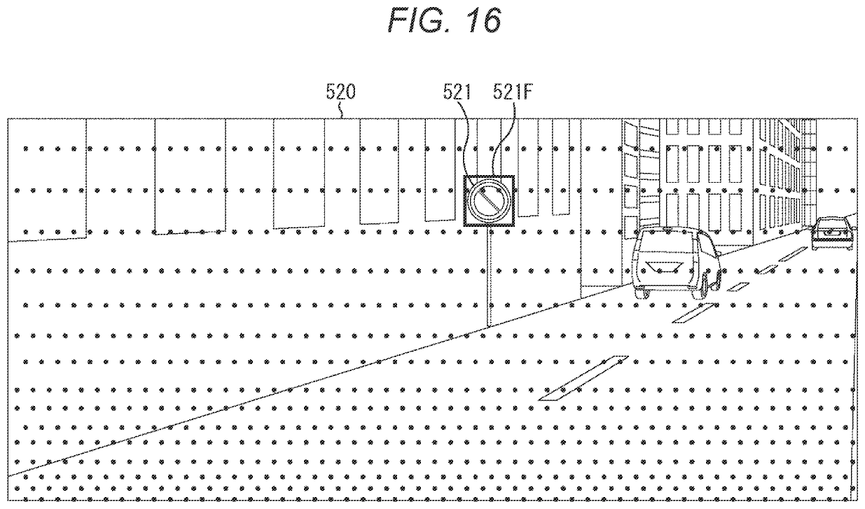

Normally, as illustrated in FIG. 16, for example, the point cloud data of LiDAR becomes denser as it is closer to the road surface and becomes sparse as it is farther from the road surface in an imaged image 520. In the example of FIG. 16, the distance information of a traffic sign 521 existing at a position away from the road surface is generated on the basis of the point cloud data corresponding to its rectangular frame 521F. However, the number of point cloud data corresponding to the object such as the traffic sign 521 or the traffic light not illustrated existing at a position away from the road surface is smaller than that of other objects existing at the position close to the road surface, and there is a possibility chat the reliability of the point cloud data becomes low.

Therefore, for an object existing at a position away from the road surface, the number of point cloud data corresponding to the object is increased by using a plurality of frames of point cloud data.

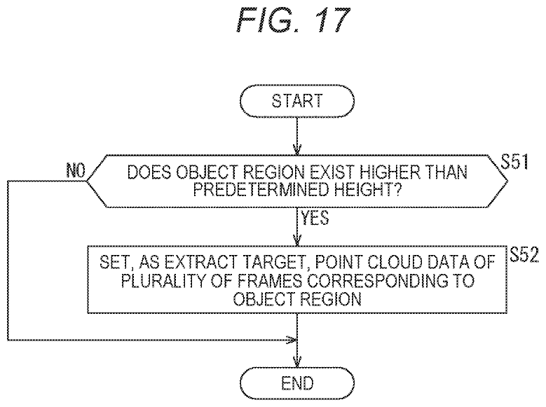

For example, in the extraction condition setting processing of point cloud data, the processing illustrated in the flowchart of FIG. 17 is executed.

In step S51, the extraction unit 342 determines whether or not the object region of the recognized object exists higher than a predetermined height in the imaged image. The height mentioned here refers to a distance from the lower end to the upper end direction of the imaged image.

In a case where it is determined that the object region exists higher than the predetermined height in the imaged image, the process proceeds to step S52, and the extraction unit 342 sets the point cloud data of the plurality of frames corresponding to the object region as the extraction target.

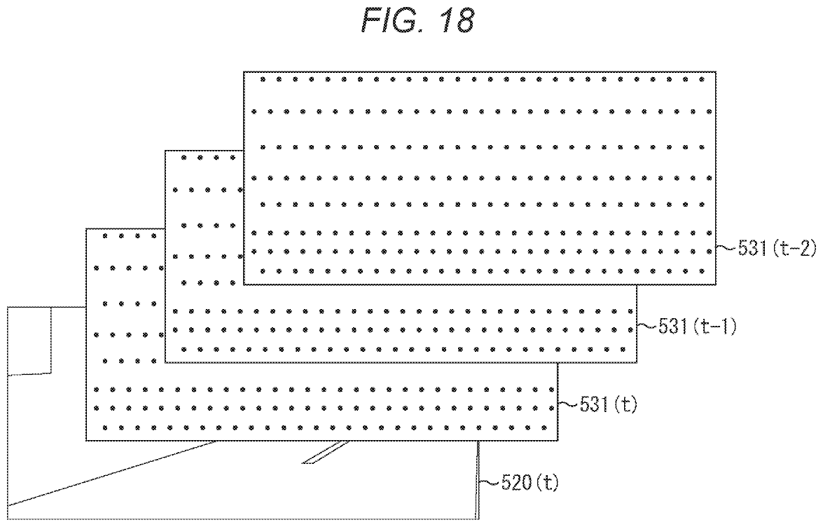

For example, as illustrated in FIG. 18, point cloud data 531(t) obtained at time t, point cloud data 531(t-1) obtained at time t-1, which is one frame before time t, and point cloud data 531(t-2) obtained at time t-2, which is two frames before time t, are superimposed on an imaged image 520(t) at current time t. Then, among the point cloud data 531(t), 531(t-1), and 531(t-2), the point cloud data corresponding to the object region of the imaged image 520(t) is set as the extraction target. Note that in a case where the subject vehicle is traveling at a high speed, the distance to the recognized object becomes closer by the time of the elapsed frame. Therefore, in the point cloud data 531(t-1) and 531(t-2), the distance information of the point cloud data corresponding to the object region is different from that of the point cloud data 531(t). Therefore, the distance information of the point cloud data 531(t-1) and 531(t-2) is corrected on the basis of the distance traveled by the subject vehicle at the time of the elapsed frame.

On the other hand, in a case where it is determined that the object region does not exist higher than the predetermined height in the imaged image, step S52 is skipped, and the point cloud data of one frame at the current time corresponding to the object region is set as the extraction target.

As described above, for an object existing at a position away from the road surface, the number of point cloud data corresponding to the object is increased by using a plurality of frames of point cloud data, and a decrease in the reliability of the point cloud data can be avoided.

### Modification 3

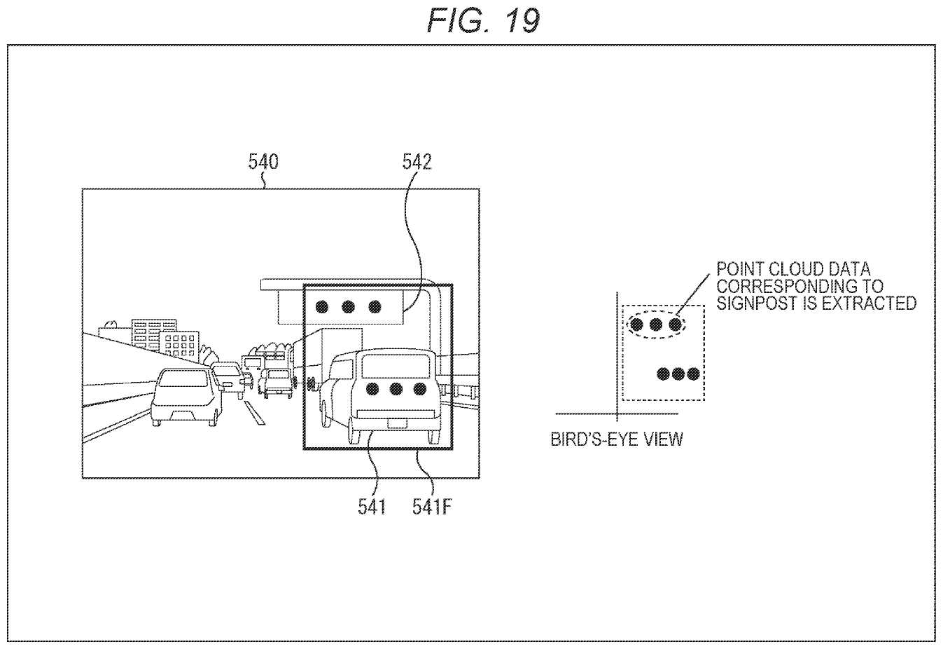

For example, as illustrated in FIG. 19, in a case where a signpost 542 is positioned above a vehicle 541 traveling in front of the subject vehicle in an imaged image 540, the signpost 542 is sometimes included in a rectangular frame 541F for the vehicle 541. In this case, as the point cloud data corresponding to the rectangular frame 541F, in addition to the point cloud data corresponding to the vehicle 541, the point cloud data corresponding to the signpost 542 is also extracted.

In this case, since the vehicle 541 moves at a predetermined speed while the signpost 542 does not move, the point cloud data for the object that does not move is excluded from the extraction target.

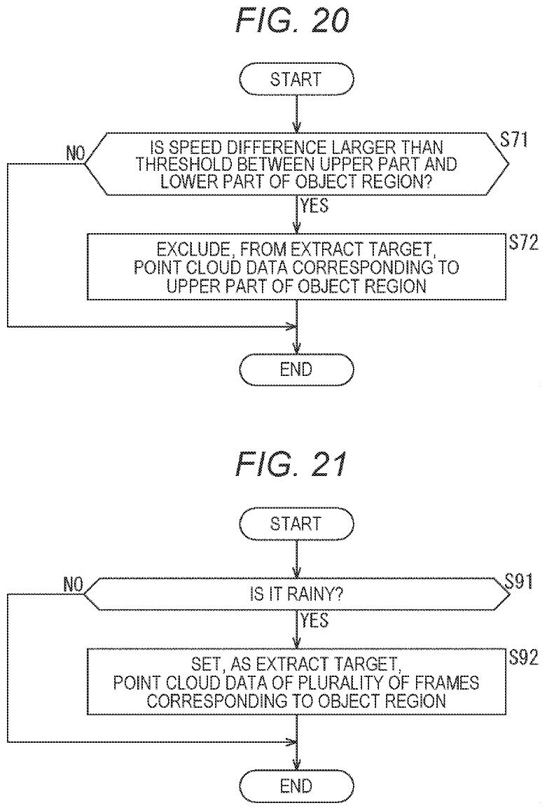

For example, in the extraction condition setting processing of point cloud data, the processing illustrated in the flowchart of FIG. 20 is executed.

In step S71, the extraction unit 342 determines whether or not the speed difference calculated on the basis of the time-series change of the point cloud data is larger than a predetermined threshold between the upper part and the lower part of the object region for the object recognized in the imaged image.

Here, it is determined whether or not the speed calculated on the basis of the point cloud data in the upper part of the object region is substantially 0, and moreover, a difference between the speed calculated on the basis of the point cloud data in the upper part of the object region and the speed calculated on the basis of the point cloud data in the lower part of the object region is obtained.

In a case where it is determined that the speed difference between the upper part and the lower part of the object region is larger than the predetermined threshold, the process proceeds to step S72, and the extraction unit 342 excludes the point cloud data corresponding to the upper part of the object region from the extraction target.

On the other hand, in a case where it is determined that the speed difference between the upper part and the lower part of the object region is not larger than the predetermined threshold, step S72 is skipped, and the point cloud data corresponding to the entire object regions is set as the extraction target.

As described above, the point cloud data for an object that does not move such as a signpost or a signboard above the vehicle can be excluded from the extraction target.

### Modification 4

In general, since LiDAR is susceptible to rain, fog, and dust, in rainy weather, the rangefinding performance of LiDAR deteriorates, and the reliability of the point cloud data extracted corresponding to the object region also decreases.

Therefore, by using the point cloud data of a plurality of frames depending on the weather, the point cloud data extracted corresponding to the object region is increased, and a decrease in the reliability of the point cloud data is avoided.

For example, in the extraction condition setting processing of point cloud data, the processing illustrated in the flowchart of FIG. 21 is executed.

In step S91, the extraction unit 342 determines whether or not the weather is rainy.

For example, as the vehicle information obtained via the CAN 332, the extraction unit 342 determines whether or not it rains on the basis of detection information from a raindrop sensor that detects raindrops in a detection area of the front windshield. Furthermore, the extraction unit 342 may determine whether or not it is rainy on the basis of the operation state of the wiper. The wiper may operate on the basis of detection information from the raindrop sensor, or may operate in response to an operation of the driver.

In a case where it is determined that the weather is rainy, the process proceeds to step S92, and the extraction unit 342 sets the point cloud data of a plurality of frames corresponding to the object region as the extraction target as described with reference to FIG. 18.

On the other hand, in a case where it is determined that the weather is not rainy, step S92 is skipped, and the point cloud data of one frame at the current time corresponding to the object region is set as the extraction target.

As described above, in rainy weather, by using the point cloud data of a plurality of frames, it is possible to increase point cloud data extracted corresponding to the object region and to avoid a decrease in the reliability of the point cloud data.

### 5. Configuration and Operation of Information Processing Apparatus

In the above, an example in which the present technology is applied to an evaluation apparatus that compares distance information of the recognition system with Point cloud data of the LiDAR in a so-called off-board manner has been described.

The present technology is not limited to this, and can also be applied to a configuration in which object recognition is performed in real time (on-board) in a traveling vehicle.

(Configuration of Information Processing Apparatus)

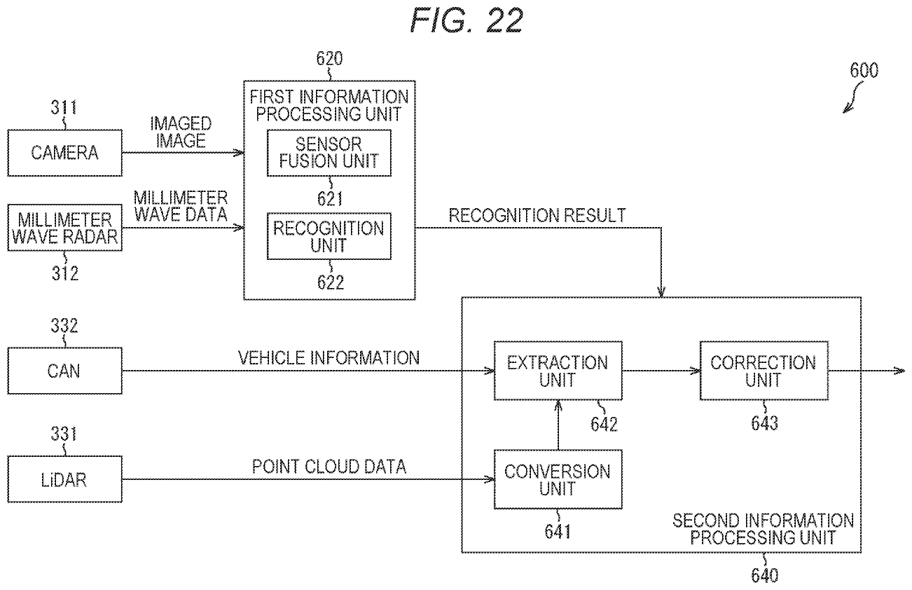

FIG. 22 is a block diagram illustrating the configuration of an information processing apparatus 600 that performs on-board object recognition.

FIG. 22 illustrates a first information processing unit 620 and a second information processing unit 640 constituting the information processing apparatus 600. For example, the information processing apparatus 600 is configured as a part of the analysis unit 61 in FIG. 1, and recognizes an object around the vehicle 1 by performing sensor fusion processing.

The first information processing unit 620 recognizes the object around the vehicle 1 on the basis of an imaged image obtained by the camera 311 and millimeter wave data obtained by the millimeter wave radar 312.

The first information processing unit 620 includes a sensor fusion unit 621 and a recognition unit 622. The sensor fusion unit 621 and the recognition unit 622 have functions similar to those of the sensor fusion unit 321 and the recognition unit 322 in FIG. 4.

The second information processing unit 640 includes a conversion unit 641, an extraction unit 642, and a correction unit 643. The conversion unit 641 and the extraction unit 642 have functions similar to those of the conversion unit 341 and the extraction unit 342 in FIG. 4.

The correction unit 643 corrects distance information included in a recognition result from the first information processing unit 620 on the basis of point cloud data from the extraction unit 642. The corrected distance information is output as a rangefinding result of the object that becomes the recognition target. Note that the accuracy of the corrected distance information can be further enhanced by using the mode value of the point cloud data existing in the rectangular frame as the point cloud data used for correction.

(Rangefinding Processing of Object)

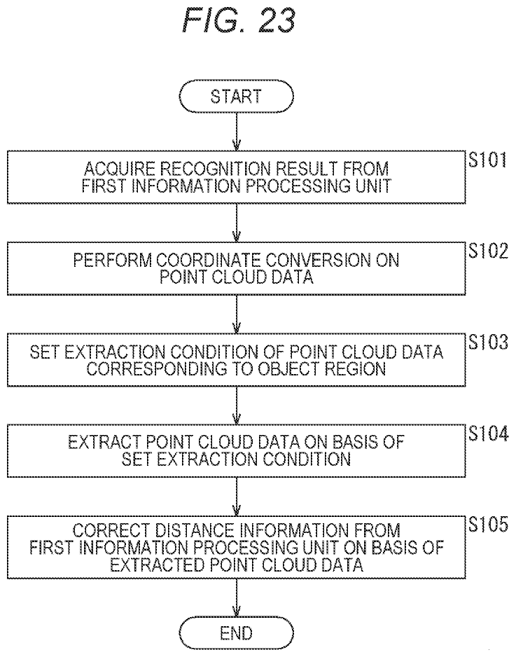

Next, rangefinding processing of an object by the information processing apparatus 600 will be described with reference to the flowchart in FIG. 23. The processing in FIG. 23 is executed on-board at a traveling vehicle.

In step S101, the extraction unit 642 acquires the recognition result of the object recognized in the imaged image from the first information processing unit 620.

In step S102, the conversion unit 641 performs coordinate conversion on the point cloud data obtained by the LiDAR 331.

In step S103, the extraction unit 642 sets, on the basis of the object, an extraction condition of the point cloud data corresponding to the object region of the object recognized in the imaged image by the first information processing unit 20 among the point cloud data converted into the camera coordinate system.

Specifically, the extraction condition setting processing of point cloud data described with reference to the flowcharts of FIGS. 12 and 13 is executed.

In step S104, the extraction unit 642 extracts the point cloud data corresponding to the object region for the recognized object on the basis of the set extraction condition.

In step S105, the correction unit 643 corrects the distance information from the first information processing unit 620 on the basis of the point cloud data extracted by the extraction unit 642. The corrected distance information is output as a rangefinding result of the object that becomes the recognition target.

According to the above processing, it is possible to narrow down the point cloud data corresponding to the recognition target, and it becomes possible to perform comparison between the distance information correction accurately with a low load. Furthermore, since the extraction condition (clustering condition) of the point cloud data is set according to the state of the object that is the recognition target, it is possible to more reliably extract the point cloud data corresponding to the object that is the recognition target. As a result, it is possible to correct distance information more accurately, and eventually it becomes possible to obtain the distance to the object more accurately, and it becomes possible to suppress false recognition (false detection) of the object, and to prevent detection omission of the object to be detected.

In the above-described embodiment, the sensor used in the sensor fusion processing is not limited to the millimeter wave radar, and may be a LiDAR or an ultrasonic sensor. Furthermore, the sensor data obtained by the rangefinding sensor is not limited to point cloud data obtained by the LiDAR, and distance information indicating the distance to the object obtained by the millimeter wave radar may be used.

Although an example in which the vehicle is the recognition target has been mainly described above, a discretionary object other than a vehicle can be the recognition target.

Furthermore, the present technology can also be applied to a case of recognizing a plurality of types of objects.

Furthermore, in the above description, an example of recognizing an object in front of the vehicle 1 has been described, but the present technology can also be applied to a case of recognizing an object in another direction around the vehicle 1.

Moreover, the present technology can also be applied to a case of recognizing an object around a moving body other than a vehicle. For example, moving bodies such as a motorcycle, a bicycle, a personal mobility, an airplane, a ship, a construction machine, and an agricultural machine (tractor) are assumed. Furthermore, the moving body to which the present technology can be applied includes, for example, a moving body that is remotely driven (operated) without being boarded by a user, such as a drone or a robot.

Furthermore, the present technology can also be applied to a case of performing recognition processing of a target at a fixed place such as a monitoring system, for example.

### 6. Configuration Example of Computer

The above-described series of processing can be executed by hardware and can be executed by software. In a case where the series of processing is executed by software, a program constituting the software is installed from a program recording medium to a computer incorporated in dedicated hardware, a general-purpose personal computer, and the like.

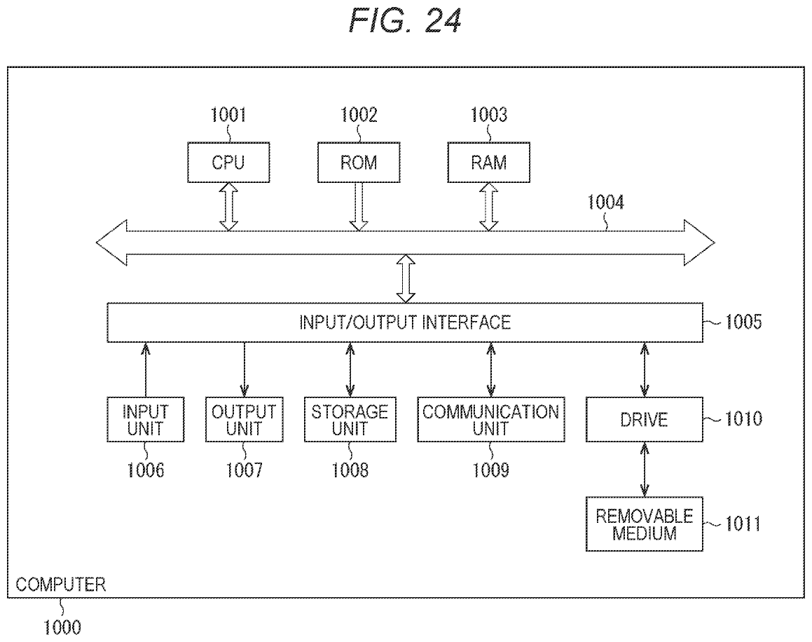

FIG. 24 is a block diagram illustrating the configuration example of hardware of a computer that executes the above-described series of processing by a program.

The evaluation apparatus 340 and the information processing apparatus 600 described above are achieved by a computer 1000 having the configuration illustrated in FIG. 24.

A CPU 1001, a RPM 1002, and a RAM 1003 are connected to one another by a bus 1004.

An input/output interface 1005 is further connected to the bus 1004. An input unit 1006 including a keyboard and a mouse, and an output unit 1007 including a display and a speaker are connected to the input/output interface 1005. Furthermore, a storage unit 1008 including a hard disk and a nonvolatile memory, a communication unit 1009 including a network interface, and a drive 1010 that drives a removable medium 1011 are connected to the input/output interface 1005.

In the computer 1000 configured as described above, for example, the CPU 1001 loads, into the RAM 1003 via the input/output interface 1005 and the bus 1004, and executes a program stored in the storage unit 1008, whereby the above-described series of processing is performed.

The program executed by the CPU 1001 is provided, for example, by being recorded in the removable medium 1011 or via a wired or wireless transmission medium such as a local area network, the Internet, or digital broadcasting, and is installed in the storage unit 1008.

Note that the program executed by the computer 1000 may be a program in which processing is performed in time series in the order described in the present description, or may be a program in which processing is performed in parallel or at necessary timing such as when a call is made.

In the present description, a system means a set of a plurality of constituent elements (apparatuses, modules (components), and the like), and it does not matter whether or not all the constituent elements are in the same housing. Therefore, a plurality of apparatuses housed in separate housings and connected via a network and one apparatus in which a plurality of modules is housed in one housing are both systems.

The embodiment of the present technology is not limited to the above-described embodiment, and various modifications can be made without departing from the gist of the present technology.

Furthermore, the effects described in the present description are merely examples and not to be limited to this, and other effects may be present.

Moreover, the present technology can have the following configurations.

(1)

An information processing apparatus including:

an extraction unit that extracts, on the basis of an object recognized in an imaged image obtained by a camera, sensor data corresponding to an object region including the object in the imaged image among the sensor data obtained by a rangefinding sensor.

(2)

The information processing apparatus according to (1), in which

the extraction unit sets an extraction condition of the sensor data on the basis of the object having been recognized.

(3)

The information processing apparatus according to (2), in which

the extraction unit excludes, from an extraction target, the sensor data corresponding to a region overlapping another object region for another object in the object region.

(4)

The information processing apparatus according to (2) or (3), in which

the extraction unit excludes, from an extraction target, the sensor data in which a difference between a speed of the object having been recognized and a speed calculated on the basis of a time-series change of the sensor data is larger than a predetermined speed threshold.

(5)

The information processing apparatus according to any of (2) to (4), in which

the extraction unit excludes, from an extraction target, the sensor data in which a distance to the object having been recognized is larger than a predetermined distance threshold.

(6)

The information processing apparatus according to (5), in which

the extraction unit sets the distance threshold in accordance with the object having been recognized.

(7)

The information processing apparatus according to (6), in which

the camera and the rangefinding sensor are mounted on a moving body, and

the extraction unit changes the distance threshold in accordance with a moving speed of the moving body.

(8)

The information processing apparatus according to any of (2) to (7), in which

in a case where the object region is larger than a predetermined area, the extraction unit sets only sensor data corresponding to a vicinity of a center of the object region as an extraction target.

(9)

The information processing apparatus according to (8), in which

in a case where the object region is smaller than a predetermined area, the extraction unit sets sensor data corresponding to an entirety of the object region as an extraction target.

(10)

The information processing apparatus according to any of to (9), in which

in a case where the sensor data corresponding to the object region is in a predetermined positional relationship, the extraction unit sets only the sensor data corresponding to a part of the object region as an extraction target.

(11)

The information processing apparatus according to any of to (10), in which

in a case where the object region exists higher than a predetermined height in the imaged image, the extraction unit sets sensor data of a plurality of frames corresponding to the object region as an extraction target.

(12)

The information processing apparatus according to any of (2) to (11), in which

in a case where a difference is speed calculated on the basis of time-series change in the sensor data between an upper part and a lower part of the object region is larger than a predetermined threshold, the extraction unit excludes, from an extraction target, the sensor data corresponding to an upper part of the object region.

(13)

The information processing apparatus according to any of to (12), in which

the extraction unit sets, as an extraction target, sensor data of a plurality of frames corresponding to the object region in accordance with weather.

(14)

The information processing apparatus according to any of (1) to (13) further including:

a comparison unit that compares the sensor data extracted by the extraction unit with distance information obtained by sensor fusion processing based on the imaged image and other sensor data.

(15)

The information processing apparatus according to any of (1) to (13) further including:

a sensor fusion unit that performs sensor fusion processing based on the imaged image and other sensor data; and

a correction unit that corrects distance information obtained by the sensor fusion processing on the basis of the sensor data extracted by the extraction unit.

(16)

The information processing apparatus according to any of (1) to (15), in which

the rangefinding sensor includes a LiDAR, and

the sensor data is point cloud data.

(17)

The information processing apparatus according to any of (1) to (15), in which

the rangefinding sensor includes a millimeter wave radar, and

the sensor data is distance information indicating a distance to the object.

(18)

An information processing method, in which

an information processing apparatus extracts, on the basis of an object recognized in an imaged image obtained by a camera, sensor data corresponding to an object region including the object in the imaged image among the sensor data obtained by a rangefinding sensor.

(19)

A program for causing a computer to execute

processing of extracting, on the basis of an object recognized in an imaged image obtained by a camera, sensor data corresponding to an object region including the object in the imaged image among the sensor data obtained by a rangefinding sensor.

### REFERENCE SIGNS LIST

1 Vehicle
61 Analysis unit
311 Camera
312 Millimeter wave radar
320 Recognition system
321 Sensor fusion unit
322 Recognition unit
331 LiDAR
332 CAN
340 Evaluation apparatus
341 Conversion unit
342 Extraction unit
343 Comparison unit
600 Information processing apparatus
620 First information processing unit
621 Sensor fusion unit
622 Recognition unit
640 Second information processing unit
641 Conversion unit
642 Extraction unit
643 Correction unit

1. An information processing apparatus comprising:
an extraction unit that extracts, on a basis of an object recognized in an imaged image obtained by a camera, sensor data corresponding to an object region including the object in the imaged image among the sensor data obtained by a rangefinding sensor.

2. The information processing apparatus according to claim 1, wherein
the extraction unit sets an extraction condition of the sensor data on a basis of the object having been recognized.

3. The information processing apparatus according to claim 2, wherein
the extraction unit excludes, from an extraction target, the sensor data corresponding to a region overlapping another object region for another object in the object region.

4. The information processing apparatus according to claim 2, wherein
the extraction unit excludes, from an extraction target, the sensor data in which a difference between a speed of the object having been recognized and a speed calculated on a basis of a time-series change of the sensor data is larger than a predetermined speed threshold.

5. The information processing apparatus according to claim 2, wherein
the extraction unit excludes, from an extraction target, the sensor data in which a distance to the object having been recognized is larger than a predetermined distance threshold.

6. The information processing apparatus according to claim 5, wherein
the extraction unit sets the distance threshold in accordance with the object having been recognized.

7. The information processing apparatus according to claim 6, wherein
the camera and the rangefinding sensor are mounted on a moving body, and
the extraction unit changes the distance threshold in accordance with a moving speed of the moving body.

8. The information processing apparatus according to claim 2, wherein
in a case where the object region is larger than a predetermined area, the extraction unit sets only sensor data corresponding to a vicinity of a center of the object region as an extraction target.

9. The information processing apparatus according to claim 8, wherein
in a case where the object region is smaller than a predetermined area, the extraction unit sets sensor data corresponding to an entirety of the object region as an extraction target.

10. The information processing apparatus according to claim 2, wherein
in a case where the sensor data corresponding to the object region is in a predetermined positional relationship, the extraction unit sets only the sensor data corresponding to a part of the object region as an extraction target.

11. The information processing apparatus according to claim 2, wherein
in a case where the object region exists higher than a predetermined height is the imaged image, the extraction unit sets sensor data of a plurality of frames corresponding to the object region as an extraction target.

12. The information processing apparatus according to claim 2, wherein
in a case where a difference in speed calculated on a basis of time-series change in the sensor data between an upper part and a lower part of the object region is larger than a predetermined threshold, the extraction unit excludes, from an extraction target, the sensor data corresponding to an upper part of the object region.

17. The information processing apparatus according to claim 2, wherein
the extraction unit sets, as an extraction target, sensor data of a plurality of frames corresponding to the object region in accordance with weather.

14. The information processing apparatus according to claim 1 further comprising:
a comparison unit that compares the sensor data extracted by the extraction unit with distance information obtained by sensor fusion processing based on the imaged image and other sensor data.

15. The information processing apparatus according to claim 1 further comprising:
a sensor fusion unit that performs sensor fusion processing based on the imaged image and other sensor data; and
a correction unit that corrects distance information obtained by the sensor fusion processing on a basis of the sensor data extracted by the extraction unit.

16. The information processing apparatus according to claim 1, wherein
the rangefinding sensor includes a LiDAR, and
the sensor data is point cloud data.

17. The information processing apparatus according to claim 1, wherein
the rangefinding sensor includes a millimeter wave radar, and
the sensor data is distance information indicating a distance to the object.

18. An information processing method, wherein
an information processing apparatus extracts, on a basis of an object recognized in an imaged image obtained by a camera, sensor data corresponding to an object region including the object in the imaged image among the sensor data obtained by a rangefinding sensor.

19. A program for causing a computer to execute
processing of extracting, on a basis of an object recognized in an imaged image obtained by a camera, sensor data corresponding to an object region including the object in the imaged image among the sensor data obtained by a rangefinding sensor.
